(19) United States
(12) Patent Application Publication
(10) Pub. No.: US 2009/0194299 A1
(43) Pub. Date: Aug. 6, 2009

(54) Flexible Hose Supply Line For Appliance Fire Suppression System

(76) Inventors: Mark C. Neumann, Peshtigo, WI (US); James A. Engman, Marinette, WI (US)

Correspondence Address: BRINKS HOFER GILSON & LIONE, P.O. BOX 10395, CHICAGO, IL, 60610, US

(21) Appl. No.: 12/026,212

(22) Filed: Feb. 5, 2008

(51) Int. Cl. A62C 3/00

(52) U.S. Cl. 169/65

(57) ABSTRACT

A fire suppression system for an appliance is provided. The fire suppression system includes a fire suppression storage container for storing a fire suppression agent, a detection system that interacts with a release assembly, a release assembly in communication with the fire suppression storage container for controlling the release of the fire suppression agent from the fire suppression storage container, a nozzle in a fixed position relative to the appliance, and a fire suppression agent conduit from the fire suppression storage container to the nozzle. The fire suppression agent conduit acts as a conduit for the fire suppression agent from the fire suppression storage container to the nozzle. The fire suppression agent conduit may partly include hard piping and partly include a flexible hose. Since the flexible hose is bendable, it enables movement of the appliance so that the area around the appliance may be cleaned. Further, swivel connectors may connect the flexible hose with the hard piping, thereby reducing the possibility that the flexible hose kinks during movement of the appliance. In addition, a restraining cable may be connected between the appliance and a wall, thereby limiting the appliance movement and reducing the possibility of damage to the flexible hose.

### BACKGROUND

Cooking appliances, such as those found in restaurants, may have the potential to create a fire. In order to reduce this possibility, a fire suppression system may be configured to work in combination with the cooking appliance. The basic fire suppression system includes a liquid agent storage tank that houses liquid agent (such as a fire suppression liquid), a release assembly with a release mechanism (such as a lever to activate the fire suppression system), nozzles, and other accessories. Black iron pipe is used to connect the liquid agent storage tank with the nozzles. The nozzles may direct the liquid agent into a variety of places, and may be positioned to protect the appliance, the hood duct, and the plenums. Typically, the nozzles are attached to the hood duct. However, some appliances are piped in a non-traditional way in that the nozzles are hard piped directly to the cooking appliance. This method usually is the only solution to offer listed protection for the particular hazard being protected. The hard piping, however, may make cleaning the appliance more difficult. In particular, the cooking appliances should be moved to clean under and around the appliance. In order to do this, the fire suppression system should be disconnected so that the cooking appliance can be moved. This is both difficult to perform and inadvisable due to the possibility that the fire suppression system is reconnected incorrectly or not reconnected at all. Accordingly, a need exists to enable easier cleaning of the cooking appliance when the nozzles of the fire suppression system are hard piped to the cooking appliance.

### SUMMARY

The present embodiments relate to a fire suppression system for an appliance, such as a cooking appliance. The fire suppression system includes a fire suppression storage container for storing a fire suppression agent, a release assembly in communication with the fire suppression storage container for controlling the release of the fire suppression agent from the fire suppression storage container (such as a lever to release the fire suppression agent on the cooking appliance), at least one nozzle in a fixed position relative to the appliance (such as connected to the appliance), and a fire suppression agent conduit from the fire suppression storage container to the at least one nozzle. Other components include detectors, cartridges if tanks are not pressurized, liquid agent, fusible links, pulley tees, and pulley elbows, mechanical or electrical gas valves, remote manual pull station(s), pressure switches; Accessories may also be added, such as alarms, warning lights etc.

The fire suppression agent conduit is adapted to act as a conduit for the fire suppression agent from the fire suppression storage container to the nozzle. At least a part of the fire suppression agent conduit comprises a flexible hose. Specifically, the fire suppression agent conduit may partly include hard piping and partly include a flexible hose. The flexible hose in the fire suppression agent conduit is bendable, thus enabling movement of the appliance so that the area around the appliance may be cleaned.

The fire suppression agent conduit may further include one or more connectors to connect the hard piping to the flexible hose. For example, zero, one, or more swivel connectors may be used to connect to none, one, or both ends of the flexible hose. The swivel connects reduce the possibility that the flexible hose kinks during movement of the appliance. The swivel connectors may be integral with the flexible hose (and connectable with the hard piping) or may be integral with the hard piping (and connectable with the flexible hose.

Further, a restraining cable (or other type of tether) may be connected between the appliance and a non-movable object (such as a wall). The restraining cable is of a length such that if the appliance is moved (such as for cleaning), the appliance's mobility is limited by the restraining cable so that the flexible hose is not damaged.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 illustrates one embodiment of a fire suppression system with a flexible hose in combination with a cooking appliance.

FIG. 2 illustrates a side view of a pressure fryer with multiple nozzles and restraining cable.

FIG. 3 illustrates a top view of an appliance with a nozzle and a restraining cable.

FIG. 4 illustrates the restraining cable and an exploded view of the hardware for connecting the restraining cable to the appliance.

### DETAILED DESCRIPTION

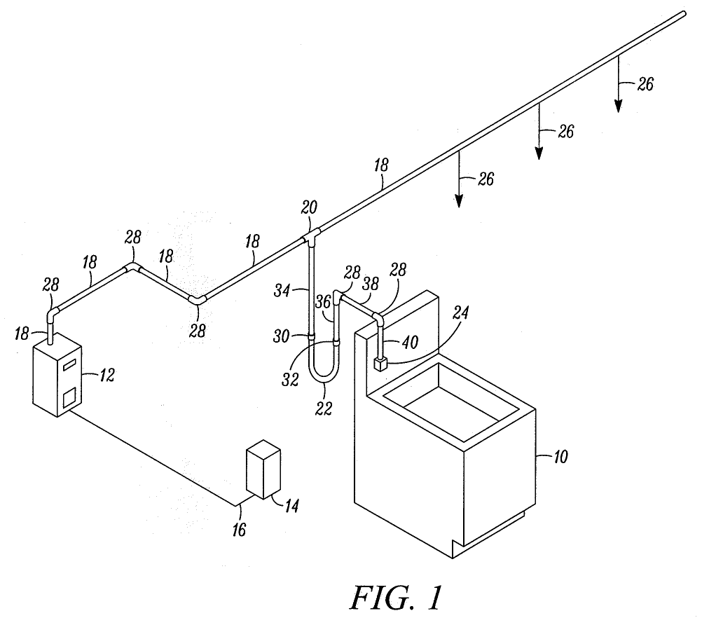

FIG. 1 shows one example of a fire suppression system in combination with an appliance. The appliance may comprise a cooking appliance 10, as shown in FIG. 1. Examples of the appliance, without limitation, include a fryer, upright broiler, and pizza oven. The fire suppression system may include a liquid agent storage tank 12 that houses liquid agent (not shown), and a release assembly with a release mechanism. For example, release mechanism may comprise a lever 14 to activate the fire suppression system, with the pulling of the lever 14 being communicated to the liquid agent storage tank 12 via line 16. The fire suppression system may further include one or more nozzles 24 positioned to direct the fire suppression agent onto any portion of the cooking appliance 10.

The liquid storage tank 12 may be connected to the nozzles via a combination of hard piping and a flexible hose. In particular, hard piping 18, 34, 36, 38, 40 in combination with elbows 28 and t-joints 20 may be used in routing part of the liquid agent from the storage tank 12 to the nozzle 24, as shown in FIG. 1. Further, the flexible hose 22 and swivel connectors 30 and 32 may be used. In this way, the flexible hose 22 allows the appliance 10 to be moved (such as moved forward, backward, rightward or leftward).

The flexible hose 22 may be bendable. One example of flexible hose 22 is a Dormant® hose with a 1½ in. bend radius. Another example of flexible hose 22 may be a rubber hose. The flexible hose 22 may be approximately 4 feet long. Alternatively, the flexible hose may be longer or shorter with an inside diameter of ⅜ in or may be larger or smaller. Further, one, some, or all of pipes 34, 36, 38, and 40 may be replaced with a flexible hose that is of longer length. In particular, the flexible hose of sufficient length may be connected from t-joint 20 to any one of elbows 28 (depicted in FIG. 1 as connected to either end of hard pipe 38). Though only one flexible hose 22 is depicted in FIG. 1, multiple flexible hoses may be used for a single appliance 10 or multiple hoses may be used within a single suppression system leading to multiple appliances.

Moreover, the flexible hose 22 (including the outer cover and the inner lining) may be selected such that it may sufficiently withstand bending (such as when the appliance is moved for cleaning). The composition of the hose reduces the likelihood that the hose will kink or crush.

As discussed above, the swivel connectors 30 and 32 may be used in order to reduce the possibility that the flexible hose 22 may kink when the appliance is moved in and out of place. The swivel connects 30 and 32 though need not be included on one or both of the ends of the flexible hose 22. One or both of the swivels 30, 32 may be integral or permanently connected with the flexible hose 22. Further, the connection of the flexible hose 22, via swivels 30, 32, to the hard pipes 34, 36 may be oriented in a vertical down position, as depicted in FIG. 1. Moreover, the hose connections may be 26″ to 30″ off of the finished floor. In this way, in order to configure the system, the swivels may be physically connected to one end of hard pipes 34 and 36. Alternatively, one or both of the swivels 30, 32 may be integral or permanently connected with one end of hard pipes 34 and 36.

As shown in FIG. 1, the hard piping 18 may comprise a main line from which one or more branches 26 may be connected. FIG. 1 depicts one branch which is used for appliance 10. More branches 26 may similarly be connected to the main line so that different appliances (such as different appliances in a kitchen) may be connected to the main line. Further, a flexible hose may be used in one, some, or all of the branches 26.

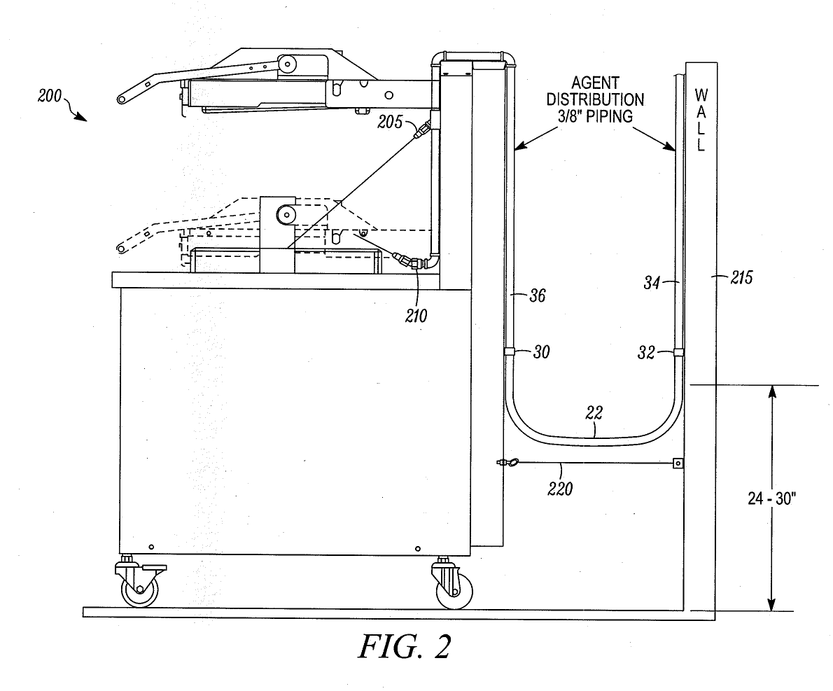

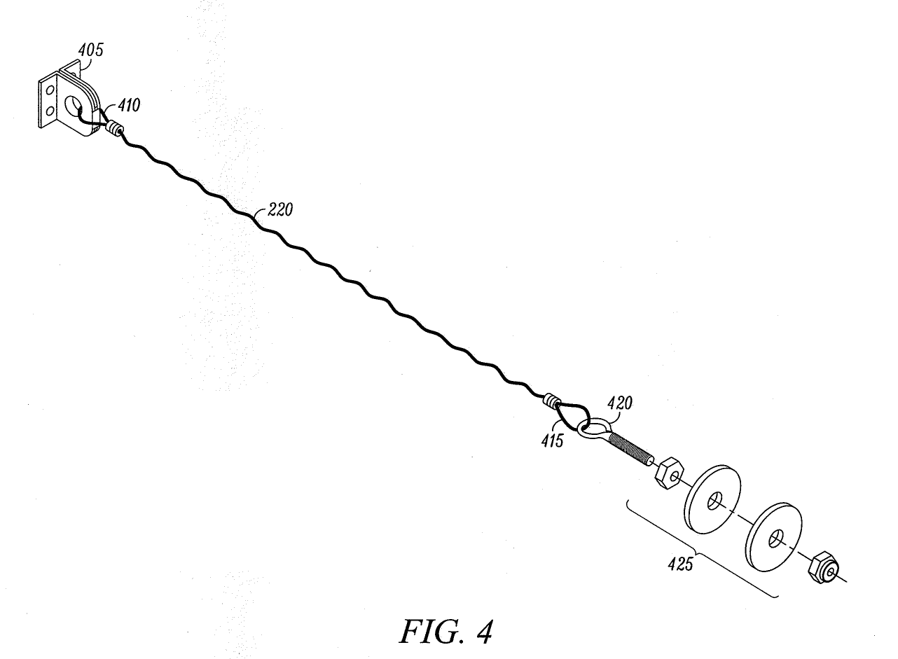

FIG. 2 illustrates a side view of a pressure fryer 200 with multiple nozzles 205, 210 and restraining cable 220. The restraining cable 220 (and associated hardware) is discussed in more detail with respect to FIG. 4. The term restraining cable encompasses any sort of flexible tether connected between the appliance and a non-movable object (such as a wall, hood, etc.).

The restraining cable 220 acts to restrain or restrict the pressure fryer 200 from being moved too far from wall 215 (or other non-movable object) so that the flexible hose 22 is not damaged through over-extension. As shown in FIG. 2, the length of the restraining cable 220 is less than the length of the flexible hose 22. In this way, if the pressure fryer 200 were pulled too far, the flexible hose 22 may be pulled from one or both of the swivels 30, 32. The restraining cable 220 may be used to prevent this from happening. FIG. 2 depicts the restraining cable 220 as being fully extended.

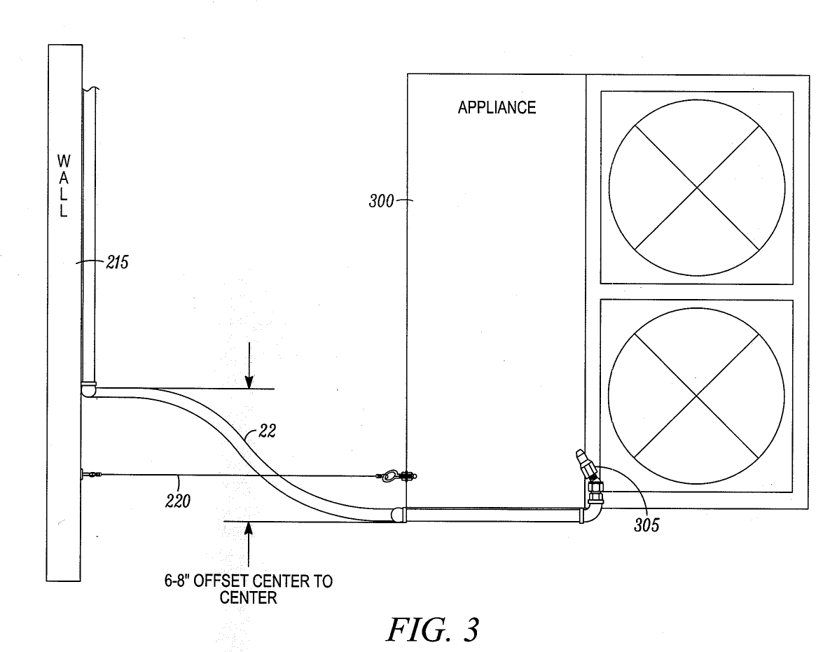

FIG. 3 illustrates a top view of an appliance 300 with a nozzle 305 and a restraining cable 220. Again, FIG. 3 depicts the restraining cable 220 as being fully extended. Only one restraining cable 220 is shown in FIG. 3. However, more than one restraining cable 220 may be used. For example, the restraining cable 220 depicted in FIG. 3 is connected to one side of the appliance 300. Another restraining cable 220 may be placed on the other side of the appliance 300. Further, if the appliance 300 is situated in a corner of a room, restraining cables 220 may be connected between the appliance 300 and each wall of the corner. In this way, the movement of the appliance 300 may be limited so that the flexible hose 22 is not damaged. In addition, FIG. 3 depicts flexible hose 22 as offset, with the ends of the flexible hose 22 being offset 6″ to 8″ center to center of fittings. This may extend the life of the flexible hose 22. With the appliance in its normal operating position, the bend in the flexible hose may be more than a 3″ bend radius (6″ diameter).

FIG. 4 illustrates the restraining cable 220 and an exploded view of the hardware for connecting the restraining cable to the appliance. Specifically, the restraining cable 220 may include one or more snap hooks 410, 415, with one snap hook 410 being connected to the wall (or other non-movable object) and the other snap hook 415 being connected to the appliance. As shown in FIG. 4, snap hook 410 is connected to the wall via staple bracket 405. Snap hook 415 is connected to the appliance via eye bolt 420 and eye bolt fastening hardware 425. Though FIG. 4 depicts the hardware for connecting to the wall and the appliance, respectively, as staple bracket 405 and eye bolt/eye bolt fastening hardware, other types of connecting devices may be used. Similarly, though the restraining cable 220 uses snap hooks 410, 415, other types of fasteners may be used.

While the invention has been described with reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention. Other modifications may likewise be made.

1. A fire suppression system for an appliance comprising:
a fire suppression storage container for storing a fire suppression agent;
a release assembly in communication with the fire suppression storage container for controlling the release of the fire suppression agent from the fire suppression storage container;
at least one nozzle in a fixed position relative to the appliance; and
a fire suppression agent conduit from the fire suppression storage container to the at least one nozzle, the fire suppression agent conduit adapted to act as a conduit for the fire suppression agent from the fire suppression storage container to the at least one nozzle,
wherein at least a part of the fire suppression agent conduit comprises a flexible hose.

2. The fire suppression system of claim 1, wherein the fire suppression agent conduit comprises hard piping and at least one hose.

3. The fire suppression system of claim 2, wherein the fire suppression agent conduit comprises a first section of hard piping is connected to a first end of the flexible hose via a first connector and a second section of hard piping is connected to a second end of the flexible hose via a second connector.

4. The fire suppression system of claim 3, wherein at least one of the first and second connectors comprises a swivel connector.

5. The fire suppression system of claim 3, wherein the first and second connectors comprises swivel connectors.

6. The fire suppression system of claim 5, wherein the swivel connectors are integral with the flexible hose; and
wherein the first and second sections of hard piping are connectable with the swivel connectors.

7. The fire suppression system of claim 1, wherein the fire suppression agent conduit comprise elbows and t-joints.

8. The fire suppression system of claim 1, wherein the at least one nozzle is connected to the appliance.

9. The fire suppression system of claim 1, wherein the appliance is movable; and
further comprising at least one flexible restraining cable, a first end of the flexible restraining cable being connected to the appliance and a second end of the flexible restraining cable being connected to a non-movable object.

10. The fire suppression system of claim 9, wherein a length of the flexible restraining cable is less than a length of the flexible hose.

11. The fire suppression system of claim 9, wherein a plurality of restraining cables are connected between the appliance and a wall.
